(19) United States
(12) Patent Application Publication
(10) Pub. No.: US 2014/0016973 A1
(43) Pub. Date: Jan. 16, 2014

(54) Printer Heat Recovery Mechanism

(71) Applicant: Carlton E. Begeal, Golden, CO (US)

(72) Inventor: Carlton E. Begeal, Golden, CO (US)

(21) Appl. No.: 13/548,589

(22) Filed: Jul. 13, 2012

(51) Int. Cl. G03G 15/20

(52) U.S. Cl. 399/330

(57) ABSTRACT

A print engine is disclosed. The print engine includes a fusing system having a heat pipe to recover heat generated by the fusing system and transfer the recovered heat back into the fusing system.

### FIELD OF THE INVENTION

The invention relates to the field of printing, and in particular, to providing energy efficiency in a printing system.

### BACKGROUND

Printers are common peripheral devices attached to computers. A printer allows a computer user to make a hard copy of documents that are created in a variety of applications and programs on a computer. Laser printers employ a xerographic printing process to produce high quality text and graphics images on a print medium via direct scanning of a laser beam across the printer's photoreceptor.

Continuous forms laser printers implement thermal fusing systems to affix toner to a medium, such as paper. These fusing systems account for approximately seventy five percent (75%) of the energy consumed by the printer's print engine. For instance, a typical fusing system may consume 11.2 kilowatts (kW) on average, which is equivalent to heat generated by 150×75 W light bulbs (or approximately nine times the average US household electricity). Thus, for organizations that operate several printing systems, the cost of electricity, heat generation, and environmental impact are significant operating factors.

Accordingly, a mechanism to recover and utilize a portion of heat generated by the print engine is desired.

### SUMMARY

In one embodiment, a print engine is disclosed. The print engine includes a fusing system having a heat pipe to recover heat generated by the fusing system and transfer the recovered heat back into the fusing system.

In another embodiment, a method is disclosed including recovering heat generated by a print engine fusing system and transferring the recovered heat back into the fusing system.

### BRIEF DESCRIPTION OF THE DRAWINGS

A better understanding of the present invention can be obtained from the following detailed description in conjunction with the following drawings, in which:

FIG. 1 illustrates one embodiment of a printing system;

FIG. 2 illustrates one embodiment of a printer paper path; and

FIG. 3 illustrates one embodiment of a heat pipe.

### DETAILED DESCRIPTION

A mechanism to recover heat generated by the print engine is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

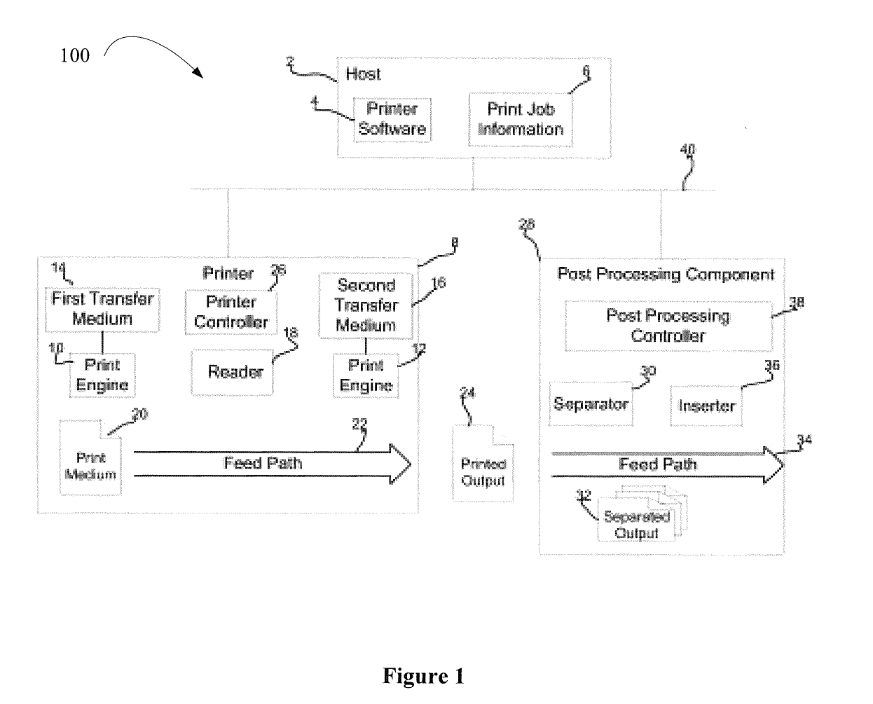

FIG. 1 illustrates one embodiment of a printing system 100. Printing system 100 includes a host system 2 having print software 4 to manage print jobs and to maintain print job information 6 on the status of print jobs managed by the print software. In one embodiment, print software 4 may be implemented using either InfoPrint Manager (IPM) or InfoPrint ProcessDirector (IPPD), although other types of printing software may be used instead.

The term print job as used herein refers to a print job or any component thereof, including a page of print content, a page including multiple print items or elements, such as checks, pages, an element on a page, etc. The print job may further include one or more pages, where each page has one or more elements, e.g., checks. A page may include a unit of print output, where the page may be outputted on a single piece of paper or multiple pages may be outputted on a roll, ribbon or web of paper.

Pages may be outputted on a web of paper in different formats, such as 2-up duplex. Each of the pages on a web or roll of paper may include multiple elements. The web of paper may include print jobs, where each print job is one or more pages, and where each page includes one or more elements. In this way, elements and pages may be grouped in print jobs.

The host system 2 may include a processor (not shown) and memory (not shown) in which the print software 4 and print job information 6 is stored for access by the processor. The host system 2 communicates print jobs to the printer 8, where each print job may have one or more pages or elements, and where each page may have one or more elements. The printer 8 includes a first print engine 10 and second print engine 12 to print output using first 14 and second 16 types of transfer media and a reader 18 capable of reading content printed using the first transfer medium 14.

Transfer media 14 and 16 include the material or energy that is used to cause the formation of content on the print medium 20, such as toner, liquid ink, solid ink, dye, wax, heat (which when applied to thermal paper produces the print content), etc. A print medium 20, such as a piece of paper or other material or textile, is directed through a feed path 22 by mechanical components of the printer 8, such as rollers, guides, etc. In the feed path 22, the first print engine 10 prints first content of the one or more pages of one or more print jobs on print medium 20 using first transfer medium 14. The first content that is printed may comprise an element, a page, a page of elements, etc.

The reader 18 reads the printed first print content to determine the quality of the output. The reader 18 may read each element on one or more pages to determine the quality of each outputted element. The reader 18 forwards the print medium 20 to the second print engine 12 to print second content using the second transfer medium 16 to produce printed output 24 including one or more print jobs of one or more pages having one or more elements printed using both types 14 and 16 of transfer media.

The printer 8 may include a printer controller 26 to control printing operations and interface with the printer software 4 to execute the commands from the printer software 4 and provide feedback thereto. The print engines 10 and 12 may include the hardware and/or software to control the printing of content using the first 14 and second 16 types of transfer media, respectively.

The printed output 24 is forwarded to a post processing component 28 which performs various post processing operations on the printed output 24. The additional post processing performed on the separated output 32 pieces may include stapling, collating, printing, labeling, etc. The post processing component 28 then outputs the separated output 32 in a final form, which may comprise envelopes including the separated output 32 pieces. The post processing component 28 may include a post processing controller 38 to control post processing operations and interface with the printer controller 26 and printer software 4 to execute the commands from the printer software 4 and provide feedback thereto.

An interface 40 provides intercommunication among the host 2, the printer 8, and the post processing component 20. The interface 40 may include a network, such as a Local Area Network (LAN), a Wide Area Network (WAN), a wireless network, etc. Alternatively, the interface 40 may include a bus interface, parallel interface, serial interface, or other direct line connection. In the embodiment of described herein, the host 2, printer 8, and post processing component 20 are shown as included in separate boxes. In an alternative implementation, the printer 8 and post processing component 20 may be included in a single machine connected via one connection to the host 2. Alternatively, all three devices 2, 8, and 20 may be included in one machine.

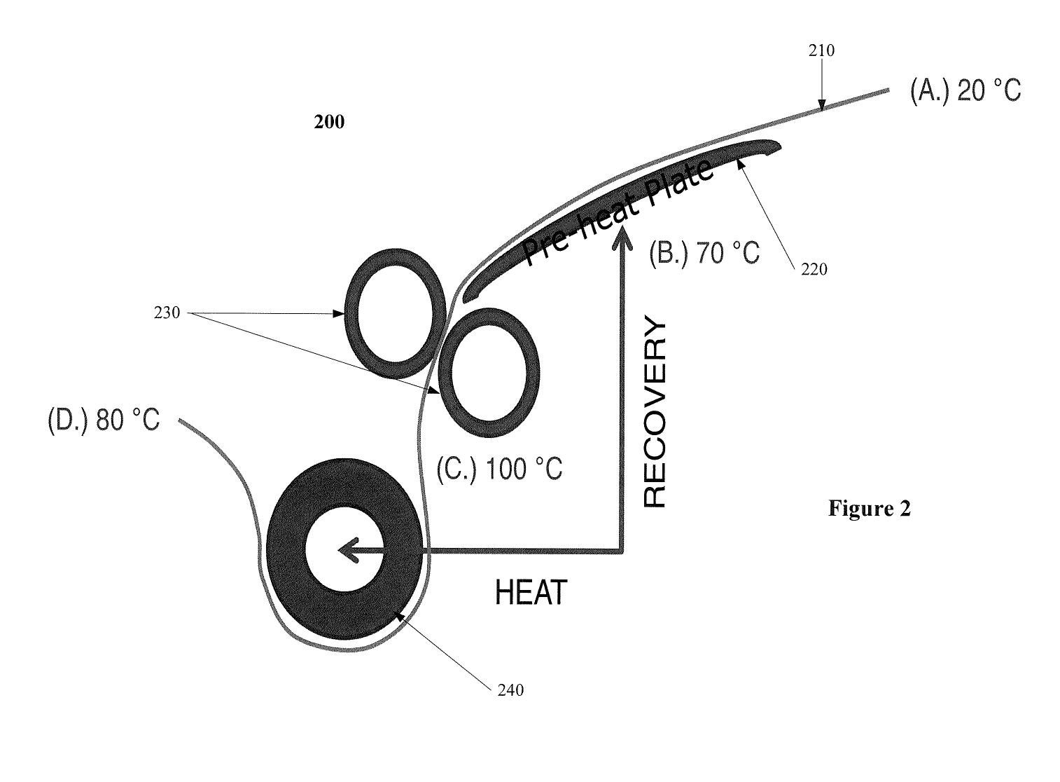

FIG. 2 illustrates one embodiment of a transfer medium 200, such as medium 14 and 16 shown in FIG. 1. As shown in FIG. 2, transfer medium 200 includes a fusing system over which print medium 210 passes in order to fuse ink on to medium 210. In such an embodiment, the fusing system is a three-stage system (e.g., low temperature pre-heat, high temperature pre-heat and hot roll fuse), including pre-heat plate 220, heat rollers 230 and heat transfer roller 240.

As medium 210 travels through the fusing system, it's temperature is raised from ambient (e.g., 20° C.) to approximately 70° C. upon passing over pre-heat plate 220, before reaching a temperature of approximately 100° C. upon passing through heat rollers 230. After exiting transfer medium 200 and print engine, the 100° C. medium 210 is cooled back down to ambient temperature through heat transfer to the environment.

According to one embodiment, roller 240 is included to reduce heat transfer to the environment by recovering waste heat and returning heat back to pre-heat plate 220. Such a reduction is enabled by heat transfer temperature gradient (e.g., 30° C.) between the hot medium 210 exiting transfer medium 200 and the low temperature pre-heat plate 220.

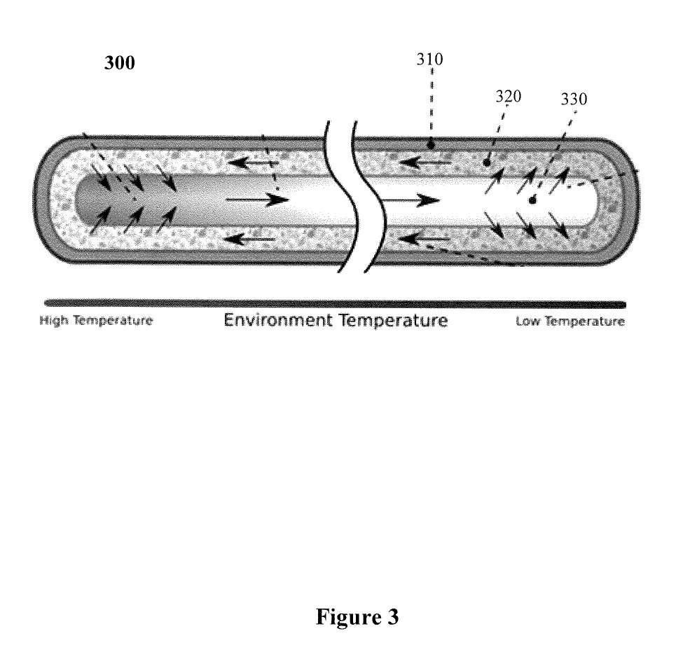

In one embodiment, a heat pipe is inserted within roller 240 in order to transport energy from the heat transfer. FIG. 3 illustrates one embodiment of a heat pipe 300. Heat pipe 300 includes a casing 310, a wick 320 and vapor cavity 330. In one embodiment, heat pipe 300 performs a thermal cycle that enables heat to be transferred back to pre-heat plate 220.

During a first step of the thermal cycle, working fluid evaporates to vapor absorbing thermal energy. Subsequently, the vapor migrates along cavity 330 to the lower temperature end. Next, vapor condenses back to fluid and is absorbed by wick 310, thus, releasing thermal energy. Finally, working fluid flows back to the higher temperature end.

The above-describe mechanism provides recovery of heat generated by a print engine, thus reducing power consumption and waste heat transferred to the environment.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A print engine comprising a fusing system having a heat pipe to recover heat generated by the fusing system and transfer the recovered heat back into the fusing system.

2. The print engine of claim 1 wherein the heat pipe is inserted within a roller.

3. The print engine of claim 2 wherein the fusing system further comprises:
a pre-heat plate to heat a medium to a first temperature; and
heat rollers to heat the medium to a second temperature.

4. The print engine of claim 3 wherein the heat pipe recovers waste heat from the medium at the second temperature and transfers the heat to the pre-heat plate.

5. The print engine of claim 1 wherein the heat pipe comprises:
a casing;
a wick within the casing; and
vapor cavity within the wick.

6. The print engine of claim 5 wherein fluid in the wick at a high temperature side of the heat pipe evaporates to vapor within the vapor cavity.

7. The print engine of claim 6 wherein the vapor migrates to a low temperature side of the heat pipe within the vapor cavity.

8. The print engine of claim 7 wherein the vapor condenses to the fluid at the low temperature side of the heat pipe within the vapor cavity.

9. The print engine of claim 8 wherein the wick absorbs the fluid.

10. The print engine of claim 9 wherein the fluid flows back to the high temperature side of the heat pipe within the wick.

11. A method comprising:
recovering heat generated by a print engine fusing system; and
transferring the recovered heat back into the fusing system.

12. The method of claim 11 wherein recovering the heat comprises a heat pipe recovers waste heat from a print medium at a first temperature and transferring the heat to a pre-heat stage of the fusing system.

13. The method of claim 12 wherein recovering the heat comprises fluid in a wick at a high temperature side of the heat pipe evaporating to vapor within a vapor cavity of the heat pipe.

14. The method of claim 13 further comprising the vapor migrating to a low temperature side of the heat pipe within the vapor cavity.

15. The method of claim 14 wherein transferring the heat comprises vapor condensing to the fluid at the low temperature side of the heat pipe within the vapor cavity.

16. The method of claim 15 further comprising:
the wick absorbing the fluid; and
the fluid flowing back to the high temperature side of the heat pipe within the wick.

17. A printer transfer medium comprising:
a pre-heat plate to heat a print medium to a first temperature;
heat rollers to heat the print medium to a second temperature; and
a heat transfer roller including a heat pipe to recover heat from the print medium and transfer the recovered heat back to the pre-heat plate.

18. The printer transfer medium of claim 17 wherein the heat pipe is inserted within a roller.

19. The printer transfer medium of claim 17 wherein the heat pipe comprises:
a casing;
a wick within the casing; and
vapor cavity within the wick.

20. The printer transfer medium of claim 19 wherein fluid in the wick at a high temperature side of the heat pipe evaporates to vapor within the vapor cavity.
